(19) United States
(12) Patent Application Publication
(10) Pub. No.: US 2017/0105193 A1
(43) Pub. Date: Apr. 13, 2017

(54) METHOD AND APPARATUS FOR DUAL-SIM CALL MANAGEMENT

(71) Applicant: MEDIATEK INC., Hsin-Chu City (TW)

(72) Inventors: Te-Huang Liu, Zhubei City (TW); Huang-Yi Yu, New Taipei City (TW); Chia-Feng Yeh, Tainan City (TW); Chih-Kuang Wu, Jhubei City (TW); Cheng-Hsien Chang, Hsinchu City (TW)

(73) Assignee: MEDIATEK INC., Hsin-Chu City (TW)

(21) Appl. No.: 15/291,951

(22) Filed: Oct. 12, 2016

Related U.S. Application Data
(60) Provisional application No. 62/240,705, filed on Oct. 13, 2015.

(51) Int. Cl. H04W 68/02

(52) U.S. Cl. CPC H04W 68/02; H04W 88/06

(57) ABSTRACT

Aspects of the disclosure provide a method for call management. The method includes receiving a signal from one of a first transceiver and a second transceiver in an electronic device. The signal indicates an incoming call managed by a first service provider that the electronic device subscribes service from. The method further includes determining whether the other of the first transceiver and the second transceiver is operative in an active call managed by a second service provider that the electronic device subscribes service from, and rejecting the incoming call when the other transceiver is operative in the active call managed by the second service provider.

### INCORPORATION BY REFERENCE

This present disclosure claims the benefit of U.S. Provisional Application No. 62/240,705, “Call Management for Dual-SIM VoWiFi Devices” filed on Oct. 13, 2015, which is incorporated herein by reference in its entirety.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Users of mobile communication may want to subscribe service from multiple wireless telecommunication service providers for various reasons, such as better coverage, quality of service, cost, travel convenience and the like. In an example, a user prefers a dual-subscribe identification module (SIM) phone with two SIM card slots. In the example, the user can insert SIM cards from two wireless telecommunication service providers to register the dual-SIM phone to the two wireless telecommunication service providers, and then can use the same phone to receive wireless telecommunication service from both service providers.

### SUMMARY

Aspects of the disclosure provide a method for call management. The method includes receiving a signal from one of a first transceiver and a second transceiver in an electronic device. The signal indicates an incoming call managed by a first service provider that the electronic device subscribes service from. The method further includes determining whether the other of the first transceiver and the second transceiver is operative in an active call managed by a second service provider that the electronic device subscribes service from, and rejecting the incoming call when the other transceiver is operative in the active call managed by the second service provider.

To reject the incoming call when the other transceiver is operative in the active call managed by the second service provider, in an example, the method includes sending a response signal indicative of a reason to reject the incoming call. In another example, the method includes discarding the signal without sending a response.

To receive the signal from the one of the first transceiver and the second transceiver in the electronic device, in an embodiment, the method includes receiving a paging signal from a cellular transceiver. The paging signal indicates that the incoming call is of a circuit switched type. Then, the method includes sending an error message with a cause value via the one of the cellular transceiver that receives the signal to reject the incoming call.

In another embodiment, the method includes receiving a session initiation protocol (SIP) invite message from the one of the first transceiver and the second transceiver. The SIP invite message indicates that the incoming call is of a packet switched type. Then, the method includes sending a SIP error response with a response code via the first transceiver to reject the incoming call.

According to an aspect of the disclosure, the method can also include determining whether the incoming call interferes with the active call, and rejecting the incoming call when the incoming call interferes with the active call. To determine whether the incoming call interferes with the active call, the method includes determining whether a frequency band of the incoming call causes interference to the active call.

Aspects of the disclosure provide an apparatus that includes a first transceiver and a second transceiver configured to transmit/receive signals for voice calls. The apparatus further includes a processing circuit configured to detect that a signal received from one of the first transceiver and the second transceiver indicates an incoming call managed by a first service provider that the apparatus subscribes service from, determine whether the other of the first transceiver and the second transceiver is operative in an active call managed by a second service provider that the apparatus subscribes service from, and reject the incoming call when the other transceiver is operative in the active call managed by the second service provider.

Aspects of the disclosure provide a non-transitory computer readable medium storing program instructions for causing a processor to execute operations for call management in an electronic device. The operations include detecting that a signal received from one of a first transceiver and a second transceiver indicates an incoming call managed by a first service provider that the electronic device subscribes service from, determining whether the other of the first transceiver and the second transceiver is operative in an active call managed by a second service provider that the electronic device subscribes service from, and rejecting the incoming call when the other transceiver is operative in the active call managed by the second service provider.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a block diagram of a communication system 100 according to an embodiment of the disclosure;

FIG. 2 shows a flow chart outlining a process 200 according to an embodiment of the disclosure;

FIG. 3 shows a flow chart outlining a process 300 according to an embodiment of the disclosure; and

FIG. 4 shows a flow chart outlining a process 400 according to an embodiment of the disclosure.

### DETAILED DESCRIPTION OF EMBODIMENTS

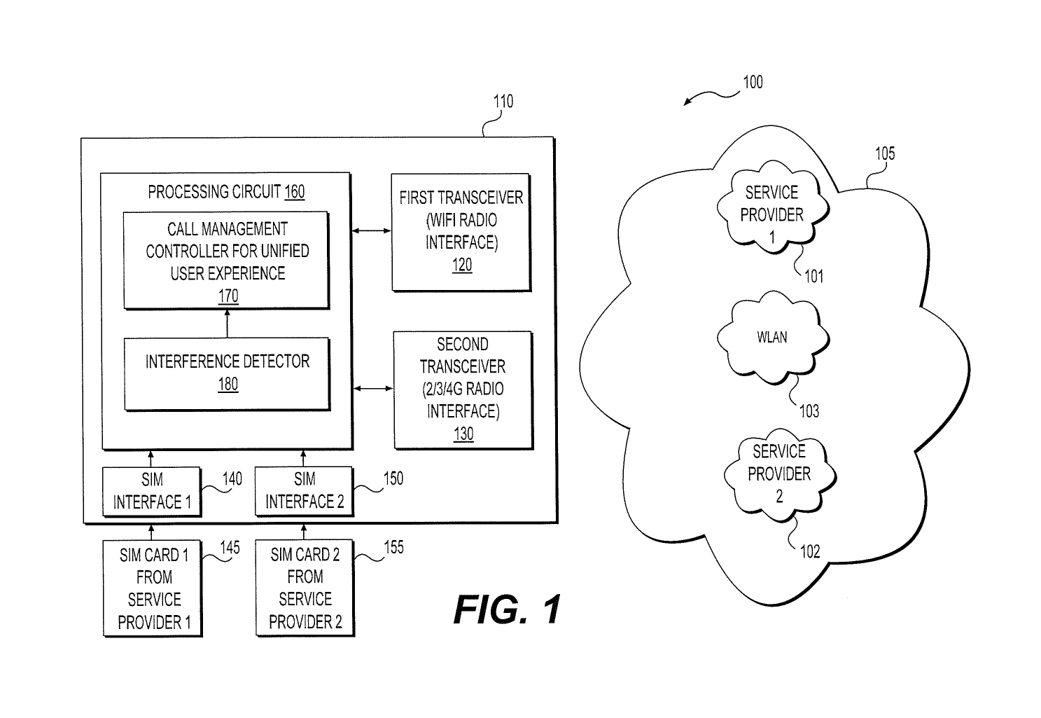

FIG. 1 shows a block diagram of a communication system 100 according to an embodiment of the disclosure. The communication system 100 includes an electronic device 110 that receives wireless communication service from a network 105. The network 105 includes multiple wireless telecommunication service providers, such as a first wireless telecommunication service provider 101, a second wireless telecommunication service provider 102 and the like, from which the electronic device 110 has subscribed telecommunication service from. The network 105 can also include a wireless local area network (WLAN) 103 when the electronic device 110 has joined the WLAN 103. The electronic device 110 includes multiple transceivers, such as a first transceiver 120 and a second transceiver 130. According to the disclosure, the electronic device 110 is configured not to accept an incoming call from a transceiver when one of the other transceivers is operative in an active call, thus that the electronic device 110 behaves consistently in various scenarios to avoid user confusion.

The network 105 includes interconnections that are implemented using any suitable network technology, such wired, wireless, a cellular communication technology, a local area network (LAN), a wireless LAN (WLAN), a fiber optical network, a wide area network (WAN), a peer-to-peer network, the Internet, and the like.

The multiple wireless telecommunication service providers can provide wireless telecommunication service using any suitable wireless communication technology, such as second generation (2G) mobile network technology, third generation (3G) mobile network technology, fourth generation (4G) mobile network technology, fifth generation (5G) mobile network technology, global system for mobile communication (GSM), long-term evolution (LTE), WLAN technology, and the like. The WLAN 103 is implemented using any suitable wireless standard, such as various IEEE 802.11 standards.

In an example, a wireless telecommunication service provider is a facility-based provider that owns the mobile infrastructure (including both hardware and software), such as cell towers, network components that form a backbone to manage and control the services provided by the wireless telecommunication service provider. In another example, a wireless telecommunication service provider is a mobile virtual network operator that does not own a mobile infrastructure, but leases telephone and data service from facility-based providers.

In an example, the wireless telecommunication service providers can provide telecommunication service using the mobile infrastructure alone, such as to a voice call of a circuit switched (CS) type, a voice over LTE (VoLTE) call, and the like. In another example, the wireless telecommunication service providers can provide telecommunication service using the mobile infrastructure and the infrastructure of the WLAN 103, such as a voice over WiFi (VoWiFi) call and the like.

According to an aspect of the disclosure, the multiple transceivers are configured to transmit/receive radio frequency signals according to different technology that can operate respectively for voice communication. In an example, the first transceiver 120 is a WiFi transceiver configured to transmit/receive radio frequency signals according to WiFi technology, such as any version of 802.11 standards, and the second transceiver 130 is a cellular transceiver configured to transmit/receive radio frequency signals according to one or more cellular communication technologies, such as 2G mobile network technology, 3G mobile network technology, 4G mobile network technology, 5G mobile network technology, GSM technology, LTE technology, and the like. Thus, the first transceiver 120 is capable to operate for a WiFi based call, such as VoWiFi call, and the second transceiver 130 is capable to operate for a cellular based call, such as a circuit switched phone call, a voice over LTE (VoLTE) call, and the like.

The electronic device 110 can be any suitable electronic device. In an example, the electronic device 110 is a terminal device used by an end-user for mobile telecommunication, such as a cell phone, a smart phone, a tablet computer, and the like. According to an aspect of the disclosure, the electronic device 110 is configured to reject an incoming call from one of the multiple transceivers when another transceiver is operative in an active call, such that the electronic device 110 behaves consistently in various scenarios in order to avoid user confusion and improve user experience in an example.

Specifically, in the FIG. 1 example, the electronic device 110 includes the first transceiver 120, the second transceiver 130, a first SIM interface 140, a second SIM interface 150, and a processing circuit 160 coupled together as shown.

The first SIM interface 140 is suitably configured to accept an SIM card, such as a first SIM card 145 provided by the first wireless telecommunication service provider 101, and couple the first SIM card 145 with other components in the electronic device 110, such as the processing circuit 160. Generally, the first SIM card 145 includes an IC chip with a memory. The memory stores various information corresponding to the first wireless telecommunication service provider 101, such as instructions for a SIM application, international mobile subscriber identity (IMSI) and related security authentication and ciphering information, user data (e.g., address book). The memory can also store temporary information related to a local network for the first wireless telecommunication service provider 101, such as public land mobile network (PLMN) lists, wireless access technologies, carrier frequency information, and the like.

In an example, based on the information stored in the first SIM card 145, the electronic device 110 is able to perform voice communication with another electronic device (not shown) under the management of the first wireless telecommunication service provider 101. The first wireless telecommunication service provider 101 manages and controls the voice communication between the electronic device 110 and the other device. For example, the first wireless telecommunication service provider 101 determines paths for the voice communication and allocates resources to enable the voice communication.

It is noted that, in an embodiment, the electronic device 110 uses a suitable transceiver to perform the voice communication via the first wireless telecommunication service provider 101. In an example, the electronic device 110 has joined the WLAN 103, and the electronic device 110 uses the first transceiver 120 to transmit/receive radio frequency signals for the voice communication according to WiFi technology. In another example, the electronic device 110 can also use the second transceiver 130 to transmit/receive radio frequency signals for the voice communication according to one or more cellular communication technologies.

Similarly, the second SIM interface 150 is suitably configured to accept an SIM card, such as a second SIM card 155 provided by the second wireless telecommunication service provider 102, and couple the second SIM card 155 with other components in the electronic device 110, such as the processing circuit 160. The second SIM card 155 also includes an IC chip with a memory. The memory stores various information corresponding to the second wireless telecommunication service provider 102, such as instructions for a SIM application, international mobile subscriber identity (IMSI) and related security authentication and ciphering information, user information (e.g., address book) and the like. The memory can also stores temporary information related to a local network for the second wireless telecommunication service provider 102, such as public land mobile network (PLMN) lists, wireless access technologies, carrier frequency information, and the like.

In an example, based on the information stored in the second SIM card 155, the electronic device 110 is able to perform voice communication with another electronic device (not shown) via the second wireless telecommunication service provider 102. The second wireless telecommunication service provider 102 manages and controls the voice communication between the electronic device 110 and the other device. For example, the second wireless telecommunication service provider 102 determines paths for the voice communication and allocates resources to enable the voice communication.

It is noted that, in an embodiment, the electronic device 110 uses a suitable transceiver to perform the voice communication via the second wireless telecommunication service provider 102. In an example, the electronic device 110 has joined the WLAN 103, and the electronic device 110 uses the first transceiver 120 to transmit/receive radio frequency signals for the voice communication according to WiFi technology. In another example, the electronic device 110 can also use the second transceiver 130 to transmit/receive radio frequency signals for the voice communication according to one or more cellular communication technologies.

The processing circuit 160 includes suitable circuits to perform various baseband processing operations, such as voice signal processing, control operations for the electronic device, application executions, and the like. Specifically, in the FIG. 1 example, the processing circuit 160 includes a call management controller 170 configured to unify user experience in various scenarios.

According to an aspect of the disclosure, calls from the same wireless telecommunication service provider can be managed by the wireless telecommunication service provider to avoid conflict, for example, an incoming call to the electronic device 110 when an active call exists at the electronic device 110. Further, the electronic device 110 is configured to manage calls coming from different wireless telecommunication service providers to avoid conflict. In some scenarios when an incoming call and an active call are from different wireless telecommunication service providers, but require the same transceiver, the incoming call is rejected. To unify the user experience in various scenarios when an incoming call and an active call are from different wireless telecommunication service providers, the call management controller 170 is configured to reject an incoming call when one of the transceivers 120-130 is in operation of an active call, no matter whether the incoming call requires operations of the same transceiver as the active call or a different transceiver from the active call.

Specifically, in an embodiment, the call management controller 170 is configured to detect an incoming call. In an example, the call management controller 170 identifies a paging message that is carried by signals received by the second transceiver 130 for example. The paging message includes a request of setting up an incoming call of a circuit switched (CS) type. The paging message includes a suitable identity of the electronic device 110, such as the IMSI of the first SIM card 145, the IMSI of the second SIM card 145, and the like to indicate a request to establish a call with the electronic device 110.

In another example, the call management controller 170 identifies a session initiation protocol (SIP) invite message that is carried by signals received from one of the first transceiver 120 and the second transceiver 130. The SIP invite message includes a request of setting up an incoming call of a packet switched type. The packet switched call is also referred to as Internet protocol (IP) multimedia subsystem (IMS) call. The SIP invite message includes IMS public user identity for the network 105 to route the SIP invite message to the recipient. In an example, when SIP invite message is received by the first transceiver 120, the SIP invite message indicates a request to establish a VoWiFi call with the electronic device 110; and when SIP invite message is received by the second transceiver 130, the SIP invite message indicates a request to establish a VoLTE call with the electronic device 110.

Further, in an embodiment, the call management controller 170 determines whether the electronic device 110 has an active call. The call management controller 170 can use any suitable technique to detect whether the electronic device 110 has an active call. For example, the call management controller 170 checks flags that are indicative of an active call. In another example, the call management controller 170 checks resource allocation status to determine whether the electronic device 110 has an active call.

In the embodiment, when the electronic device 110 is in an active call, the call management controller 170 then operates to suitably reject the incoming call. For example, the call management controller 170 is configured to use suitable technique corresponding to the incoming call to reject the incoming call.

In an example, when the incoming call is a CS call, the call management controller 170 is configured to generate an error message, and the second transceiver 130 transmits signals carrying the error message to the network 105 to reject the incoming call. In an example, the error message includes a suitable cause value (e.g., 17, 18, 41, etc.) to indicate a reason of establishment failure. In an example, the cause value 17 indicates that the establishment fails due to user busy; the cause value 18 indicates that the establishment fails due to no user responding; and the cause value 41 indicates that the establishment fails due to temporary failure.

In another example, when the incoming call is an IMS based call, the call management controller 170 is configured to generate a SIP message, and the SIP message is sent to the network 105 to reject the incoming call. In an example, the SIP message includes a SIP response code (e.g., 486, 480, 487, etc.) to indicate a reason of establishment failure. In an example, a SIP response code of 486 indicates that the establishment fails due to user busy; a SIP response code of 480 indicates that the establishment fails due to temporarily unavailable; a SIP response code of 487 indicates that the establishment fails due to request terminated.

According to another aspect of the disclosure, the call management controller 170 rejects the incoming call without sending a response. In an embodiment, when the electronic device 110 is in an active call of VoWiFi type via the first transceiver 120, the call management controller 170 triggers protocol stack to discard suitable messages for an incoming CS call via the second transceiver 130 without sending a response in order to reject the incoming call. In an example, the call management controller 170 discards a setup message from network 105 in non-access stratum (NAS) layer that manages the establishment of communication sessions. In another example, the call management controller 170 discards a CS service notification message from network 105 in the NAS layer. In another example, the call management controller 170 discards a down link (DL) paging for an incoming CS call on 2/3G radio access technology. In another example, the call management controller 170 discards a DL paging for an incoming CS call on 4G radio access technology. In another example, the call management controller 170 is configured to turn off the second transceiver 130 until the VoWiFi call by the first transceiver 120 is disconnected, such that the electronic device 110 behaves as unreachable for the incoming call.

In another embodiment, when the electronic device 110 is in an active call of VoWiFi type via the first transceiver 120, the call management controller 170 triggers protocol stack to discard messages for an incoming VoLTE call via the second transceiver 130 without sending a response in order to reject the incoming call. In an example, the call management controller 170 discards the SIP invite message from the network 105. In another example, the call management controller 170 discards a DL paging for evolved packet system (EPS) service on the 4G radio access technology. In another example, the call management controller 170 is configured to turn off the second transceiver 130 until the VoWiFi call by the first transceiver 120 is disconnected, such that the electronic device 110 behaves as unreachable for the incoming call.

In another embodiment, when the electronic device 110 is in an active call of a CS call or a VoLTE call via the second transceiver 130, the call management controller 170 triggers a protocol stack to discard messages for an incoming VoWiFi call via the first transceiver 120 without sending a response in order to reject the incoming call. In an example, the call management controller 170 discards the SIP invite message from the network 105. In another example, the call management controller 170 is configured to turn off the first transceiver 120 until the active call by the second transceiver 130 is disconnected, such that the electronic device 110 behaves as unreachable for the incoming call.

According to another aspect of the disclosure, the processing circuit 160 is configured to detect interference of an incoming call to an active call, and reject the incoming call to avoid quality degradation to the active call. In the FIG. 1 example, the processing circuit 160 includes an interference detector 180 configured to detect potential in-device coexistence interference of an incoming call to an active call, and provide the detected information to the call management controller 170. In an example, when the interference detector 180 detects that an incoming VoLTE call uses an overlapping frequency band with an active VoWiFi call, the interference detector 180 informs the call management controller 170 to reject the incoming call. In another example, when the interference detector 180 detects that an incoming VoWiFi call uses an overlapping frequency band with an active VoLTE call, the interference detector 180 informs the call management controller 170 to reject the incoming call.

The electronic device 110 can be implemented using any suitable technology. In an example, the first transceiver 120 is implemented on a first integrated circuit (IC) chip, the second transceiver 130 is implemented on a second IC chip, and the processing circuit 160 is implemented on a third IC chip. In another example, the processing circuit 160 includes a baseband processing circuit (not shown) integrated on one IC chip, and a processor (not shown) integrated on another IC chip. The electronic device 110 includes suitable memory devices (not shown) configured to store software instructions. In an example, the processor executes the software instructions to perform the functions of the call management controller 170.

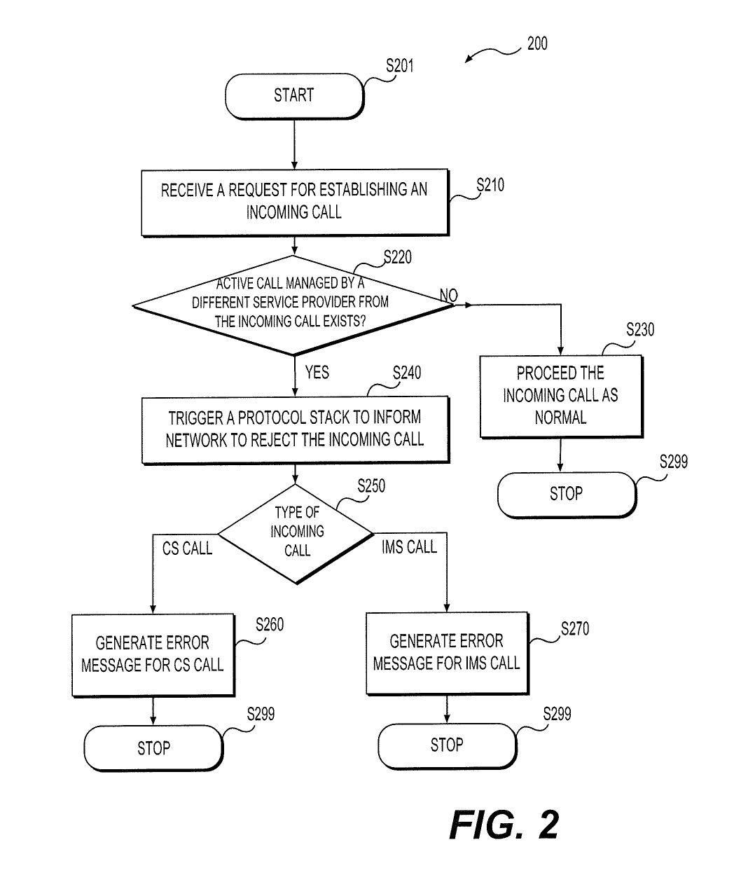

FIG. 2 shows a flow chart outlining a process 200 according to an embodiment of the disclosure. In an example, the process 200 is executed by the processing circuit 160 in the FIG. 1 example. The process starts at S201 and proceeds to S210.

At S210, a request for establishing an incoming call is received. In an example, the processing circuit 160 receives a paging message that is carried by signals received by the second transceiver 130 for example. The paging message includes a request of setting up an incoming call of the CS type. In another example, the processing circuit 160 receives a SIP invite message that is carried by signals received from the first transceiver 120. The SIP invite message includes a request of setting up an incoming call of a VoWiFi type. In another example, the processing circuit 160 receives a SIP invite message that is carried by signals received from the second transceiver 130. The SIP invite message includes a request of setting up an incoming call of a VoLTE type.

At S220, the processing circuit 160 detects whether an active call that is managed by a different wireless telecommunication service provider from the incoming call exists. When the electronic device 110 is operative in an active call managed by a different wireless telecommunication service provider from the incoming call, the process proceeds to S240; otherwise, the process proceeds to S230.

At S230, the processing circuit 160 operates in response to the request to proceed the incoming call. In an example, the processing circuit 160 generates a suitable response for the transceivers to send to the network 105 to further setup the incoming call. Then the process proceeds to S299 and terminates.

At S240, a protocol stack is triggered to inform the network 105 to reject the incoming call.

At S250, the process proceeds based on a type of the incoming call. When the incoming call is a CS call, the process proceeds to S260; and when the incoming call is an IMS call, the process proceeds to S270.

At S260, the incoming call is a CS call, the processing circuit 160 generates an error message, and the second transceiver 130 transmits signals carrying the error message to the network 105 to reject the incoming call. In an example, the error message includes a suitable cause value (e.g., 17, 18, 41, etc.) to indicate a reason of establishment failure. In an example, the cause value 17 indicates that the establishment fails due to user busy; the cause value 18 indicates that the establishment fails due to no user responding; and the cause value 41 indicates that the establishment fails due to temporary failure. Then the process proceeds to S299 and terminates.

At S270, the incoming call is an IMS based call, the processing circuit 160 generates a SIP message, and the SIP message is sent to the network 105 to reject the incoming call. When the incoming call is a VoWiFi call, in an example, the first transceiver 120 transmits radio frequency signals to carry the SIP message; and when the incoming call is a VoLTE call, in an example, the second transceiver 130 transmits radio frequency signals to carry the SIP message. In an example, the SIP message includes a SIP response code (e.g., 486, 480, 487, etc.) to indicate a reason of establishment failure. In an example, a SIP response code of 486 indicates that the establishment fails due to user busy; a SIP response code of 480 indicates that the establishment fails due to temporarily unavailable; a SIP response code of 487 indicates that the establishment fails due to request terminated. Then the process proceeds to S299 and terminates.

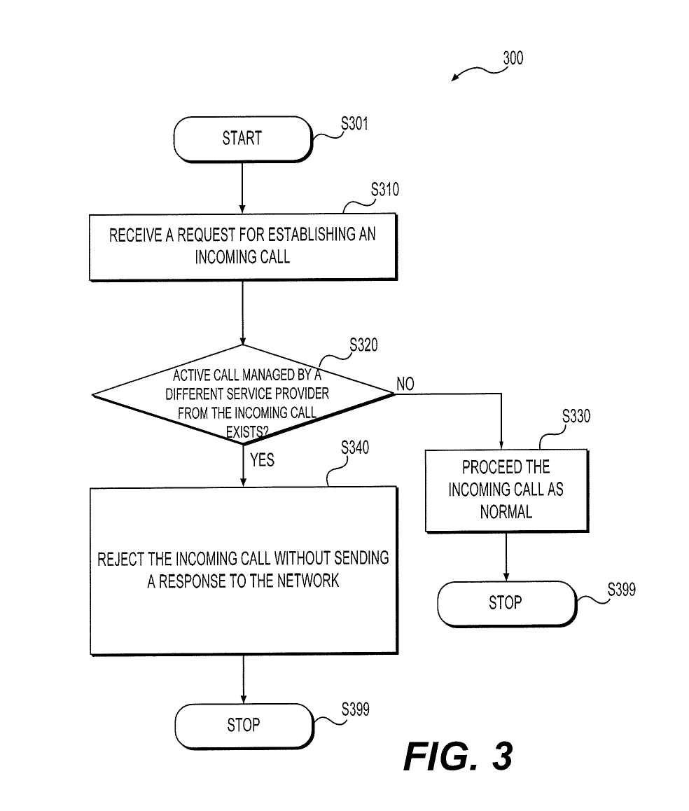

FIG. 3 shows a flow chart outlining a process 300 according to an embodiment of the disclosure. In an example, the process 300 is executed by the processing circuit 160 in the FIG. 1 example. The process starts at S301 and proceeds to S310.

At S310, a request for setting up an incoming call is received. In an example, the processing circuit 160 receives a paging message that is carried by signals received by the second transceiver 130 for example. The paging message includes a request of setting up an incoming call of the CS type. In another example, the processing circuit 160 receives a SIP invite message that is carried by signals received from the first transceiver 120. The SIP invite message includes a request of setting up an incoming call of a VoWiFi type. In another example, the processing circuit 160 receives a SIP invite message that is carried by signals received from the second transceiver 130. The SIP invite message includes a request of setting up an incoming call of a VoLTE type.

At S320, the processing circuit 160 detects whether an active call that is managed by a different wireless telecommunication service provider from the incoming call exists. When the electronic device 110 is operative in an active call managed by a different wireless telecommunication service provider from the incoming call, the process proceeds to S340; otherwise, the process proceeds to S330.

At S330, the processing circuit 160 operates in response to the request to proceed the incoming call. In an example, the processing circuit 160 generates a suitable response for the transceivers to send to the network 105 to further setup the incoming call. Then the process proceeds to S399 and terminates.

At S340, the processing circuit 160 rejects the incoming call without sending a response. In an embodiment, the processing circuit 160 triggers suitable protocol stack to discard the request without sending a response in order to reject the incoming call. In another embodiment, the processing circuit 160 turns off a portion of the electronic device 110 without sending a response in order to reject the incoming call. Then the process proceeds to S399 and terminates.

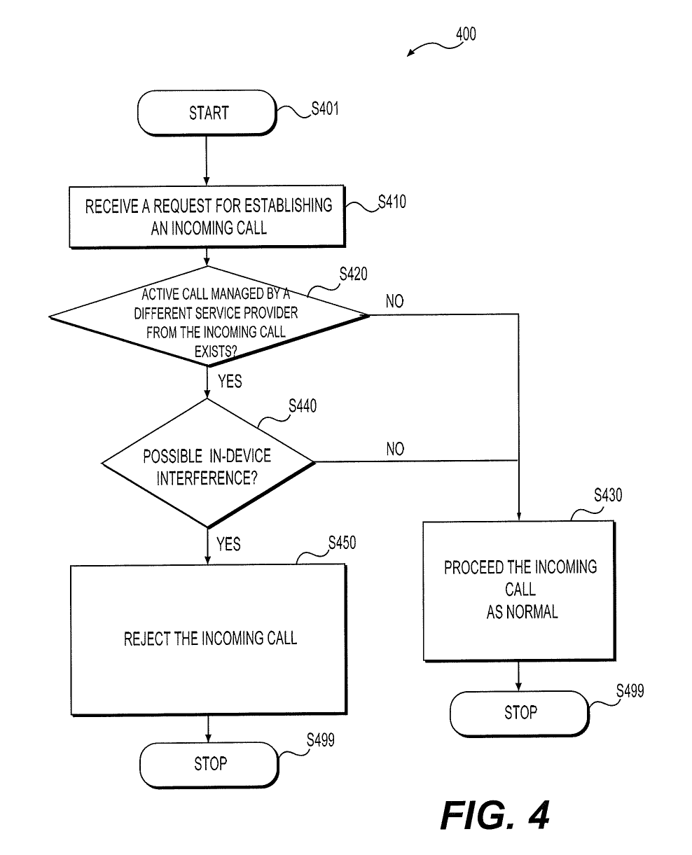

FIG. 4 shows a flow chart outlining a process 400 according to an embodiment of the disclosure. In an example, the process 400 is executed by processing circuit 160 in the FIG. 1 example. The process starts at S401 and proceeds to S410.

At S410, a request for setting up an incoming call is received. In an example, the processing circuit 160 receives a paging message that is carried by signals received by the second transceiver 130 for example. The paging message includes a request of setting up an incoming call of the CS type. In another example, the processing circuit 160 receives a SIP invite message that is carried by signals received from the first transceiver 120. The SIP invite message includes a request of setting up an incoming call of a VoWiFi type. In another example, the processing circuit 160 receives a SIP invite message that is carried by signals received from the second transceiver 130. The SIP invite message includes a request of setting up an incoming call of a VoLTE type.

At S420, the processing circuit 160 detects whether an active call that is managed by a different wireless telecommunication service provider from the incoming call exists. When the electronic device 110 is operative in an active call managed by a different wireless telecommunication service provider from the incoming call, the process proceeds to S440; otherwise, the process proceeds to S430.

At S430, the processing circuit 160 operates in response to the request to proceed the incoming call. In an example, the processing circuit 160 generates a suitable response for the transceivers to send to the network 105 to further setup the incoming call. Then the process proceeds to S499 and terminates.

At S440, the processing circuit 160 detects whether the incoming call causes potential in-device coexistence interference to an active call. When the incoming call causes potential in-device coexistence interference to an active call, the process proceeds to S450; otherwise the process proceeds to S430.

At S450, the processing circuit 160 rejects the incoming call. The processing circuit 160 can reject the incoming call using any suitable technique. In an embodiment, the processing circuit 160 rejects the incoming call in the same manner as S260 and S270. In another embodiment, the processing circuit 160 rejects the incoming call in the same manner as S340. Then the process proceeds to S499 and terminates.

When implemented in hardware, the hardware may comprise one or more of discrete components, an integrated circuit, an application-specific integrated circuit (ASIC), etc.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method for call management, comprising:
receiving a signal from one of a first transceiver and a second transceiver in an electronic device, the signal indicating an incoming call managed by a first service provider that the electronic device subscribes service from;
determining whether the other of the first transceiver and the second transceiver is operative in an active call managed by a second service provider that the electronic device subscribes service from; and
rejecting the incoming call when the other transceiver is operative in the active call managed by the second service provider.

2. The method of claim 1, wherein rejecting the incoming call when the other transceiver is operative in the active call managed by the second service provider further comprises at least one of:
sending a response signal indicative of a reason to reject the incoming call; and
discarding the signal without sending a response.

3. The method of claim 1, wherein receiving the signal from the one of the first transceiver and the second transceiver in the electronic device further comprises:
receiving a paging signal from a cellular transceiver, the paging signal indicating that the incoming call is of a circuit switched type.

4. The method of claim 3, wherein rejecting the incoming call when the other transceiver is operative in the active call managed by the second service provider further comprises:
sending an error message with a cause value via the one of the cellular transceiver that receives the signal to reject the incoming call.

5. The method of claim 1, wherein receiving the signal from the one of the first transceiver and the second transceiver in the electronic device further comprises:
receiving a session initiation protocol (SIP) invite message the one of the first transceiver and the second transceiver, the SIP invite message indicating the incoming call is of a packet switched type.

6. The method of claim 5, wherein rejecting the incoming call when the other transceiver is operative in the active call managed by the second service provider comprises:
sending a SIP error response with a response code via the first transceiver to reject the incoming call.

7. The method of claim 1, wherein the first transceiver is one of a cellular transceiver and a WiFi transceiver, and the second transceiver is of a different type from the first transceiver.

8. The method of claim 1, further comprising:
determining whether the incoming call causes in-device coexistence interference to the active call; and
rejecting the incoming call when the incoming call causes in-device coexistence interference to the active call.

9. The method of claim 8, wherein determining whether the incoming call causes in-device coexistence interference to the active call further comprise:
determining whether a frequency band of the incoming call causes interference to the active call.

10. An apparatus, comprising:
a first transceiver and a second transceiver configured to transmit/receive signals for voice calls;
a processing circuit configured to:
detect that a signal received from one of the first transceiver and the second transceiver indicates an incoming call managed by a first service provider that the apparatus subscribes service from;
determine whether the other of the first transceiver and the second transceiver is operative in an active call managed by a second service provider that the apparatus subscribes service from; and
reject the incoming call when the other transceiver is operative in the active call managed by the second service provider.

11. The apparatus of claim 10, wherein the processing circuit is configured to generate a response signal indicative of a reason to reject the incoming call for the one of the first transceiver and the second transceiver to send out.

12. The apparatus of claim 10, wherein the processing circuit is configured to discard the signal without generating a response.

13. The apparatus of claim 10, wherein the signal is a paging signal received from a cellular transceiver, the paging signal indicates that the incoming call is of a circuit switched type.

14. The apparatus of claim 13, wherein the processing circuit is configured to generate an error message with a cause value, and the cellular transceiver is configured to transmit the error message to reject the incoming call.

15. The apparatus of claim 10, wherein the signal is a session initiation protocol (SIP) invite message indicating that the incoming call is of a packet switched type.

16. The apparatus of claim 15, wherein the processing circuit is configured to generate a SIP error response with a response code, and the one of the first transceiver and the second transceiver that receives the signal is configured to transit the SIP error response to reject the incoming call.

17. The apparatus of claim 10, wherein the first transceiver is one of a cellular transceiver and a WiFi transceiver, and the second transceiver is of a different type from the first transceiver.

18. The apparatus of claim 10, wherein the processing circuit is configured to determine whether the incoming call causes in-device coexistence interference to the active call and reject the incoming call when the incoming call causes in-device coexistence interference to the active call.

19. The apparatus of claim 18, wherein processing circuit is configured to determine whether a frequency band of the incoming call causes interference to the active call.

20. A non-transitory computer readable medium storing program instructions for causing a processor to execute operations for call management in an electronic device, the operations comprising:
detecting that a signal received from one of a first transceiver and a second transceiver indicates an incoming call managed by a first service provider that the electronic device subscribes service from;
determining whether the other of the first transceiver and the second transceiver is operative in an active call managed by a second service provider that the electronic device subscribes service from; and
rejecting the incoming call when the other transceiver is operative in the active call managed by the second service provider.
